(19) United States
(12) Patent Application Publication
(10) Pub. No.: US 2001/0033879 A1
(43) Pub. Date: Oct. 25, 2001

(54) CHEESE CULTURE MEDIUM AND METHOD FOR MAKING NO FAT AND LOW FAT CHEESE PRODUCTS

(76) Inventors: CHARLES C. HUNT, PEWAUKEE, WI (US); THOMAS M. HENRY, MCHENRY, IL (US); GERALD W. URBEN, WAUKESHA, WI (US)

Correspondence Address: JEFFREY F CRAFT, PRETTY SCHROEDER & POPLAWSKI, 444 SOUTH FLOWER STREET, 19TH FLOOR, LOS ANGELES, CA, 90071

(21) Appl. No.: 09/387,825

(22) Filed: Sep. 1, 1999

(51) Int. Cl. A23C 9/12

(52) U.S. Cl. 426/36; 426/582

(57) ABSTRACT

Disclosed is culture medium and a method for preparing a no fat or low-fat cheese product. The culture medium contains from about 1 to about 5 wt.% nonfat dry milk, from about from about 0.05 to about 1.0 wt.% of at least one food grade, polyanionic gum stabilizer, and from about 90 to about 97 wt.% of a liquid portion such as water, whey, milk or reconstituted whey or milk. After a curd in whey mixture is formed, whey is removed and replaced with hot water. The diluted whey is drained, after the curd is cooked. The drained curd is salted with a mixture of salt and an emulsifying salt.

### BACKGROUND OF THE INVENTION

1. Field of the Invention

This invention relates to the food making arts. In particular, it relates to low fat and no fat, cheese products manufactured by the pressed curd process and to a method for manufacturing such cheese products.

2. Background of the Invention

In recent years, for health as well as cosmetic reasons, an increasing desire has developed for a diet that focuses on improved nutritional benefits, such as a diet that is low in low fat and low in sodium. In accordance with the Code of Federal Regulations, 21 CFR 101.65(d)(2), foods that are low in fat, saturated fat, sodium, and cholesterol can be termed “healthy”.

The public has eagerly sought products, which can be labeled as “healthy,” yet look and taste the same as their traditional counterparts. To this end, food researchers have concentrated on developing food products, which are nutritious and palatable, but which contain substantially reduced levels of fat, saturated fat, sodium, and cholesterol. This is particularly true in the dairy industry where such products as skim milk and low fat and non fat yogurt have been successfully marketed. However, the successes in these areas have not carried over to methods for preparing no fat or low fat cheeses having high consumer acceptance.

The manufacture of “healthy” cheeses may follow any of several processes that have been established for traditional higher fat cheeses to yield two basic product types, natural and processed. The details for traditional natural and processed cheeses can be found in 21 CFR 133. One process for the manufacture of natural cheese is the pressed (or fused) curd cheese process. The pressed curd process is employed to make common block cheeses such as Cheddar, Swiss, Colby, etc. Natural cheese may be converted to processed cheese by blending the base cheese with additional ingredients, typically, including a sodium-containing emulsifying salt, and cooking the blend to pasteurization temperature to control product characteristics and prolong shelf-life.

Attempts have been made to use skim milk or low fat milk with or without added fat substitutes, in the pressed curd process. Typically, in the manufacture of natural no fat or low fat cheese by the pressed curd process, raw or pasteurized skim or low fat milk is placed in a vat and heated to ripening temperature. Acid-producing bacteria, such as S. cremoris, S. lactis, S. citrovorous, L. bulgaricus, L. casei, or L. helveticus, are then added to the milk directly or through a cultured medium and the mixture ripened to achieve a desired degree of acidity and an appropriate level of flavoring compounds. The milk at this stage is known as cultured or ripened milk. A coagulating enzyme is added to the cultured milk to form a coagulum. When the coagulum has reached a desired firmness, it is cut to form a curd in whey mixture. The curd is the generally solid phase of the mixture containing protein, fat and some water, while the whey is the generally aqueous phase of the mixture containing mostly water and some solids such as lactose, minerals, protein and fat.

The vat is then heated to a predetermined temperature and held at this temperature for a period of time sufficient to cook the curd, causing the curd to continue firming and expelling whey. The whey is then drained leaving a firm, resilient curd. However, the bacteria continue to act on residual lactose retained in the curd to produce additional acid and other products which can adversely affect the body, texture, melt, and flavor of the final cheese product. This is a particular problem in the manufacture of no fat or low fat cheeses, because no fat and low fat cheeses contain more moisture than their full fat counterparts to adjust texture for the less fat. The greater amount of moisture means that there is more waterphase lactose retained in no fat and low fat curd. This increased lactose content leads to excess acid development creating undesired flavor and texture. The increased lactose content also causes excessive darkening if the resulting cheese product is melted.

Consequently, the control of acid production is critical in no fat and low fat cheese to prevent tartness associated with too much acidity. Accordingly, it is desirable to control the level of lactose remaining in the curd to control the end point of acid production and to reduce the texture, melt, and flavor defects.

Traditional pressed curd processes include the step of washing the drained curd in order to remove, residual lactose. Gamay, U.S. Pat. No. 5,395,630, for example, describes a curd washing procedure to help in controlling the pH of the curd. However, washing the drained no fat or low fat curd is both inefficient and causes an undesirably high moisture in the finished product.

Chen, C., “Reduced-Fat Cheddar Cheese Make Schedule,” Low-fat Cheddar Seminar, Center for Dairy Research, University of Wisconsin, Madison, Nov. 7, 1991, describes an alternative procedure in the manufacture of a reduced-fat Cheddar cheese. Chen teaches diluting the whey prior to cooking by draining off 20% of the whey and replacing with 10% hot water (120° F.). Chen reports, however, that the resulting cheese flavor is weaker in cheddar and higher in off-flavors. Chen also describes the body and texture of control cheeses as preferred over those of whey dilution cheeses.

After the whey is separated and washed, the curd is salted or brined. In most pressed curd cheeses, salting cannot occur until after bacteria have produced sufficient acid to cause the curd to have a pH of less than 5.5. The addition of salt has the effect, inter alia, of significantly decreasing the bacterial activity, thereby lessening production of additional acid and other bacterial byproducts. While salting has the potential to control acid development in traditional cheeses, the use of salt or any sodium containing salt to control bacterial action is not practical in a “healthy” cheese due to sodium limitations.

Attempts have also been made to convert these natural, no fat and low fat cheese products to no fat or low fat processed cheeses. Unfortunately, the body, texture, and flavor of the resulting no fat or low fat cheese processed products have not been entirely satisfactory for ordinary consumer use. Also, the melt characteristics of these cheeses have not matched those of their higher fat counterparts. These cheeses tend to be extremely hard, leathery and tough, and they are often completely devoid of flavor or have off-flavors associated with their high protein content. Therefore, there is a desire for a process which results in the preparation of no fat or low-fat cheese products having similar body, texture, melt and flavor when compared to their traditional counterparts.

Furthermore, the normal use of sodium-containing emulsifying salts in the processing of low fat and no fat cheeses presents a problem to the manufacture of “healthy” processed cheese due to sodium limitations. Therefore, there is also a desire for a low fat or no fat base cheese that can be converted to a low fat or no fat processed cheese with low sodium content, i.e., 480 mg sodium or less per 50 g cheese, to meet the requirement for “healthy” labeling.

### SUMMARY OF THE INVENTION

Now in accordance with the invention there has been found an adjunct culture medium which, when used with no fat or low fat milk, produces a no fat or low fat cheese product having the flavor, texture, and melt of full fat cheese. The adjunct culture medium contains from about 1 to about 5 wt. % nonfat dry milk, from about 0.05 to about 1.0 wt. % of at least one food-grade, polyanionic gum stabilizer, and from about 90 to about 97 wt. % of a liquid portion, such as water, whey, milk, reconstituted whey or milk, and the like, based on the total weight of the adjunct culture medium.

Representative anionic gums include agar, xanthan, alginate, guar, locust bean, carrageenan, and cellulose gels, such as carboxymethyl cellulose and the like. In preferred embodiments, the adjunct culture medium also contains a nonionic thickener, such as a food starch, which may or may not be modified chemically. Also in some embodiments, the adjunct culture medium contains at least one emulsifying salt, such as sodium citrate, potassium citrate, sodium phosphate, potassium phosphate, or combinations thereof. In some embodiments, the adjunct culture medium includes at least one nutrient source, such as yeast extract, yeast autolysate, solubilized yeast, food yeast, magnesium sulfate, enzyme-hydrolyzed casein, amino acids, proteins, nonfat dry milk, dry sweet whey, and simple sugars, such as lactose. And in some embodiments the adjunct culture medium includes flavorings, fat mimetics, fat emulsifiers, to decrease the size of the fat droplets and to disperse the fat droplets evenly, opacifying agents, such as titanium dioxide or any combination of these ingredients.

In accordance with another aspect of the invention, it has been discovered that a no fat or low fat cheese product having the flavor, texture, and melt of full fat cheese is produced when no fat or low fat curd is extracted with hot water, prior to cooking the curd.

In preferred embodiments, the adjunct culture medium is pasteurized, then cooled to a temperature suitable for growth of flavor-producing bacteria that do not significantly contribute to the overall production of acid. The adjunct culture medium is then inoculated with such flavor-producing bacteria and the mixture incubated to form an adjunct cultured mixture. Cultured milk is then made by combining, in a cheese vat, skim or low fat milk, about 0.2 wt. % of an acid-producing culture, typically in the form of a frozen concentrate or a previously cultured medium containing from about 0.5-2.0 wt. % of such acid-producing bacteria, and from about 1 to about 10 wt. % of the cultured mixture, based on the total weight of the vat contents. In some embodiments, flavor promoter, coloring, and/or calcium chloride is added along with the no fat or low fat milk, acid-producing culture, and adjunct cultured mixture. The cultured milk is allowed to ripen and sufficient coagulating enzyme is added to the ripened milk to form a coagulum. The coagulum is then cut to form a curd in whey mixture.

At this point, about 10 to about 50 wt. % of the whey, based on the weight of the curd in whey mixture, is removed. The remaining whey is then diluted by the addition of hot water, preferably having a temperature of from about 110° to about 150° F. The hot water effectively extracts lactose and other whey solids from the curd. The water is slowly added so as to affect the cooking of the curd, typically at a temperature of about 90° F. to about 120° F. over a period of about 20 to about 40 minutes. The cooked curd and the diluted whey are then transferred to a draining device and the diluted whey drained off.

In accordance with still another aspect of the invention, an emulsifying salt, preferably in an amount of from about 0.1 to about 1.0 wt. %, is added to the drained curd, based on the drained curd weight. For pressed curd cheeses, such as Cheddar, the curd is directly salted and then pressed. The addition of the emulsifying salt is facilitated by first blending the emulsifying salt with the other salt, i.e., sodium chloride. For pressed curd cheeses that are brined, such as Swiss, the curd is first pressed and then brined to incorporate salt. In brined cheeses, the emulsifying salt is advantageously added to the curd prior to pressing and brining. Flavorings, dry or wet, are added to the drained curd, before, concurrently, or subsequent to salting. After the addition of salt, emulsifying salt, and flavorings, processing is completed by cutting and packaging to produce a no fat or low fat cheese product having a body, texture and flavor similar to its full fat counterpart.

### DETAILED DESCRIPTION OF THE PREFERRED EMBODIMENTS

The adjunct culture medium in accordance with the invention contains from about 1 to about 5 wt. %, preferably from about 1 to about 3 wt. %, nonfat dry milk, based on the weight of the adjunct culture medium. The nonfat dry milk is a nutrient for the culture and provides a protein source.

The adjunct culture medium additionally contains from about 0.05 to about 1.0 wt. %, preferably from about 0.1 to about 0.5 wt. %, polyanionic gum stabilizer, based on the weight of the culture medium. Representative polyanionic gum stabilizers include agar, xanthan, alginate, guar, locust bean, carrageenan, cellulose gels, such as carboxymethyl cellulose, and the like, as well as mixtures thereof. The polyanionic gum stabilizer is added in an amount sufficient to help stabilize the solids and control moisture in the subsequently produced cultured mixture. The stabilizer also helps in preventing the resulting curd from having an undesirable rubbery texture. Without wishing to be bound by a theory of invention, it is believed that by adding the stabilizer to the adjunct culture medium certain stabilizer/milk protein/liquid portion interactions occur which enhance the body, texture, and flavor of the subsequently formed cheese product. Such interactions are less likely to occur, if they occur at all, when the stabilizer is directly added to skim or low fat milk in the cheese vat.

The adjunct culture medium also contains from about 90 to about 97 wt. %, preferably from about 91 to about 93 wt. %, of a liquid portion, based on the weight of the adjunct culture medium. Representative liquid portions include water, whey, milk, reconstituted whey or milk, and the like. The amount of liquid portion to be used in a particular application is chosen to adjust the viscosity of the adjunct culture medium.

In preferred embodiments, the adjunct culture medium also contains from about 0.5 to about 6 wt. %, preferably from about 2 to 5 wt. %, of a non-ionic thickener, such as a food starch, based on the weight of the adjunct culture medium. The non-ionic thickener is added in an amount sufficient to aid in imparting a soft texture to the resulting curd. The non-ionic thickener also develops a soft gel to the cultured mixture that prevents solids from separating, once all the ingredients have been combined to form the culture medium. Again, without wishing to be bound by a theory of invention, it is believed that the soft gel may also involve the polyanionic gum, and that this gel may ultimately be captured in the cheese curd, thereby protecting the curd structure—a role played by butterfat in full fat cheeses. Without this protection, the curd would collapse to exude moisture and form a tough rubbery structure.

In some embodiments, the adjunct culture medium also contains from about 0.1 to about 1.0 wt. %, preferably from about 0.2 to about 0.8 wt. %, of an emulsifying salt, based on the weight of the culture medium. The emulsifying salt is added in an amount sufficient to buffer the culture media and sequester calcium. Representative salts include monosodium phosphate, disodium phosphate, dipotassium phosphate, trisodium phosphate, metaphosphate (sodium hexametaphosphate), sodium acid phosphate, tetrasodium pyrophosphate, aluminum phosphate, sodium citrate, potassium citrate, calcium citrate, sodium tartrate, sodium potassium tartrate and mixtures thereof. Sodium citrate, potassium citrate, sodium phosphate or potassium phosphate are preferred. An advantage provided by phosphate-containing emulsifiers, in general, is that phosphate is a nutrient source for the acid-producing bacteria. An additional advantage provided by potassium phosphate is that potassium is also a nutrient source for the acid-producing bacteria.

It is also possible to add flavorings, typically in an amount from about 0.1 to about 5.0 wt. %, based on the weight of the adjunct culture medium. Flavorings containing little or no fat are preferred, so that they will not add significantly to the fat content of the final cheese product. Representative no fat or low fat flavorings include buttermilk solids and natural and artificial butter and dairy flavor components. Additional ingredients that can be included in the adjunct culture medium include fat mimetics, such as propylene glycol monoester (which also may help in stabilizing and evenly dispersing the fat) and opacifying agents, such as titanium dioxide.

The adjunct culture medium is made by mixing the ingredients to form a slurry. The slurry is pasteurized, for example, by heating to about 175 to about 195° F., preferably to about 185° F., for about 15 to 45 minutes, preferably for about 30 minutes. The adjunct culture medium is then cooled to a temperature of from about 40 to about 60° F., preferably about 50° F., and then inoculated with flavor-producing bacteria that do not significantly contribute to the overall production of acid.

Suitable flavor-producing bacteria for inoculating the adjunct culture medium are well known in the literature and choice of a particular bacterium or combination of bacteria will depend on the flavor and type of cheese product to be produced. Representative flavor-producing bacterium suitable for practice of the invention include, without limitation, S. citrovorous, S. cremoris, S. lactis, S. thermophilus, S. diacetylactis, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, and propionibacterium species, such Propionibacterium shermanii. After inoculation, the mixture is incubated, typically overnight, to form an adjunct cultured mixture.

The adjunct cultured mixture is added to a cheese vat containing skim milk or low fat milk which is at temperature of about 85 to 100° F., preferably about 90 to 95° F. As used herein, skim and low fat milks include equivalent compositions formed by suitable admixtures of milk solids and water. The skim or low fat milk can be raw milk, but is preferably pasteurized and fortified to a desired vat protein level. The amount of adjunct cultured mixture added to the vat is about 1 to 10 wt. %, preferably about 3 to about 8 wt. %, based on the total weight of the vat contents.

Cultured milk is formed by adding a predetermined amount of an acid-producing bacteria, typically in the form of a frozen concentrate or previously cultured medium containing such an acid-producing bacteria, to a vat containing the milk, and the adjunct cultured mixture.

Acid-producing bacteria for use in accordance with the invention are well-known to the skilled artisan. They include, but are not limited to S. cremoris, S. lactis, S. thermophilus., S. durans, S. faecalis, L. bulgaricus, L. lactis, and other acid-producing bacteria. The final butterfat level in the vat is normally in the range of from about 0.1 to about 1.0 wt. %, preferably from about 0.1 to about 0.6 wt. %, based on the weight of the cultured milk, depending on the desired fat content of the final cheese product and the casein level in the starting milk.

Other ingredients can be added to the vat containing the skim or low fat milk, adjunct cultured mixture, and acid-producing bacteria. Suitable other ingredients include calcium chloride, flavor promoters, colorings, flavorings, opacifying agents, vitamins, and minerals. Additionally, a defoamer can be added to reduce or eliminate foam that might otherwise be formed at the surface when the adjunct cultured mixture is combined with the milk, a common problem with skim and low fat milk systems.

The cultured milk is then ripened by maintaining its temperature between about 85 and about 100° F., preferably between about 90 and about 95° F., with stirring, for about 15 to about 60 minutes, preferably for about 20 to about 40 minutes. The pH of the ripened milk at the end of this period is generally from about 6.3 to about 6.6.

A clotting enzyme is mixed into the ripened milk to cause the milk to coagulate. Suitable clotting enzymes include rennet, a cloned rennet, a diluted rennin extract, a pepsin-rennin mixture, a vegetable-derived enzyme clotting agent or the like. Cloned rennet is preferred. Other enzymes such as pepsin and papain may be used alone or in combination with the rennet. After addition of the clotting enzyme, the mixture is allowed to set quiescently for about 15 to about 45 minutes, typically for about 30 minutes, to form a firm, set coagulum.

Once set, the coagulum is cut and stirred. Cutting can be accomplished with traditional wire harps in an open vat or with any other suitable equipment, such as rotating blades in an enclosed vat. Cutting the coagulum causes whey syneresis and leads to a heterogeneous mixture of solid curd in liquid whey. The desired final size and condition of the curd is obtained through the cutting and stirring procedures. The curd must be small enough to expel whey efficiently, but the curd cannot be shattered which would create an overabundance of fines. Also, the curd should be in the form of discrete particles as opposed to clumping and forming matted balls.

In an enclosed vat a proper curd size can be achieved by cutting on slow speed low rpm for about 1 to about 5 minutes, preferably for about 2 to about 3 minutes, followed by cutting at medium speed medium rpm for about 1 to about 5 minutes, preferably for about 2 to about 3 minutes, and finally cutting at fast speed fast rpm for about 3 to about 7 minutes, preferably for about 4 to about 6 minutes. The curd and whey are then slowly stirred for about 5 minutes to about 15 minutes, preferably about 10 minutes, to help firm the curd prior to the pre-draw and to assure no clumping of the curd.

Approximately 10 to 50 wt. % of the whey, preferably about 25 to 35 wt. % of the whey, based on the weight of the curd in whey mixture, is removed by stopping the stirring and drawing off the whey after the curd has settled, but before the curd begins to fuse together (matting). If necessary, the whey removal may be accomplished in two or more steps of shorter draining periods with fast or vigorous agitation between drainings to keep the curds from fusing (matting) together. The whey remaining in the vat is then diluted by adding hot water at a temperature of about 110 to about 150° F., preferably about 125° F. The hot water effectively extracts residual lactose and whey solids from the curd.

The water is added at a rate that slowly increases the curd temperature to from about 90 to about 120° F. over a period of about 20 to about 40 minutes, preferably about 30 minutes, thereby cooking the curd. The cooked curd in diluted whey is then stirred slowly until the curd pH has decreased to about 6.0 to about 6.4, preferably to about 6.1 to about 6.2.

Next, the curd and diluted whey is stirred at high speed high rpm to break up any soft lumps formed and to disperse the curd uniformly. The curd and diluted whey are then pumped to a draining system to complete whey removal. A universal or standard draining table has been found to be well suited for final whey draining. After draining, the curds are pressed to facilitate final whey removal and form a cheese mass for further processing. The pH of the pressed curd is from about 5.1 to about 5.8, preferably about 5.2 to about 5.3.

The pressed curd is then cut or formed into an appropriate size and shape. Salt, i.e., sodium chloride, can be added to the cheese product by mixing it with the curd and whey prior to draining, mixing it with the drained curd prior to pressing, brining the final cheese product, or any other suitable method to achieve a final salt level of about 0.8 to about 2.2 wt. %, preferably about 2.0 wt. %, based on the weight of the final cheese product.

In some embodiments, an emulsifying salt, preferably in an amount of from about 0.1 to about 1.0 wt. %, is added to the drained curd, based on the drained curd weight. Suitable emulsifying salts include any calcium binding salts such as sodium citrate, potassium citrate, sodium phosphate, potassium phosphate, or combinations thereof.

For pressed curd cheese products, such as Cheddar, the curd is directly salted and then pressed. The addition of the emulsifying salt is facilitated by first blending the emulsifying salt with the other salt. For pressed curd cheese products that are brined, such as Swiss, the curd is first pressed and then brined to incorporate salt. In brined cheese products, the emulsifying salt is advantageously added to the curd prior to pressing and brining. Flavorings, dry or wet, are added to the drained curd, before, simultaneously, or subsequent to salting. After the addition of salt, emulsifying salt, and flavorings, processing is completed by cutting, packaging, and aging to produce a no fat or low fat cheese product having a body, texture and flavor similar to its fall fat counterpart.

The following examples are included to further illustrate the invention. They are not a limitation thereon. All percentages are based on weight, unless otherwise clearly indicated.

### EXAMPLE 1

A low fat cheddar cheese product is prepared by the following method.

### Preparation of Adjunct Cultured Mixture

The following ingredients are mixed to form a slurry: 94% water, 2% nonfat dry milk, and 4% Special Culture Media,, an admixture of agar, xanthan gum, cellulose gel, locust bean gum, modified food starch, sodium phosphate, sodium citrate, dipotassium phosphate, propyleneglycol monoester, and titanum dioxide prepared by Crest Foods, Ashton, Ill. The resulting slurry is pasteurized at 185° F. for 30 minutes and cooled to 50° F. The slurry is inoculated with 180 ml of L. casei, obtained from Rhodia, Inc., Marshall Products Division, Madison, Wis., and stirred overnight.

### Preparation of Low Fat Milk

Whole milk is separated to standardize the low fat milk to 0.48% fat with a 3.20% protein in order to achieve an 11.5% fat in dry matter in the final cheese product. 31,000 lbs. of the standardized milk is pasteurized at 165° F. for 16 seconds and then cooled to 91° F.

### Preparation of Low Fat Cheddar Curd

At the beginning of vat fill, as 31,000 lbs. low fat milk is pumped into a Damrow Double O vat, 960 lbs. of the cultured adjunct medium is added. Acid-producing bacteria (2304 ml Chr. Hansen DVS 940 and 1280 ml Chr. Hansen LH32, obtained from Chr. Hansen Labs, Milwaukee Wis.), are added as a frozen concentrate directly to the vat, 60 minutes prior to set. Annatto cheese color, 1280 ml, is also added at this time. The combined ingredients are stirred and allowed to ripen at 91° F. for about 60 minutes from the time the acid-producing cultures are added.

After ripening, 2400 ml of cloned microbial rennet (Chymax obtained from Chr. Hansen Labs, Milwaukee Wis.) diluted with 10 times the volume of water, is poured into the ripened milk mixture. The mixture is stirred until the rennet is evenly distributed throughout the milk mixture and then allowed to set without stirring for about 30 minutes.

Once the mix becomes a firm, set coagulum, it is cut mechanically in the vat in the sequence of 2 minutes slow, 2 minutes medium, and 5 minutes fast. The result is a fine cut coagulum that will produce approximately 3/16 inch size curd for pressing. The curd and whey are slowly stirred in reverse, for 12 minutes, to help firm up the curd prior to the predraw and to assure no clumping of the curd.

Approximately one-third of the whey is removed by stopping agitation and drawing off the whey in two stages. The curd and whey are then stirred at fast speed for 3 minutes to ensure uniform curd size prior to cooking.

The cooking of the curd is accomplished by adding hot water, slowly, so that the curd reaches a temperature in the range of from about 90° F. to about 98° F. The temperature of the water is adjusted so that the temperature rise is consistent over a 25 minute period. The amount of water added is approximately one-third of the amount of whey remaining after the pre-draw.

The cooked curd and diluted whey mixture is slowly stirred until a pH of about 6.15 is reached. The mixture is then stirred at high speed to uniformly disperse the curd. Next, the curd and diluted whey mixture is pumped to an open drain table fitted with an agitator. The mixture is stirred while the diluted whey is drained to a level equal to the level of the curd. When the pH of about 5.65 is reached, the remaining whey is drained from the curd. Cold water, approximately 50° F., is immediately sprayed on the stirred curd until the temperature of the curd drops to about 85° F. This is done to prevent clumping and slow the bacterial activity.

A blend of 2% salt, and 0.5% sodium citrate, based on the estimated curd weight is prepared. The blend is uniformly applied to the curd and stirred in.

The curd is then packaged into forms, where it is pressed and vacuumed to develop a cheddar texture. The finished product is cooled to 40° F. and stored for proper aging.

### EXAMPLE 2

A low fat traditional Swiss cheese product is prepared by the following method.

### Preparation of Adjunct Cultured Mixture

An adjunct cultured mixture is prepared as described in Example 1, above.

### Preparation of Low Fat Milk

Whole milk is separated to standardize the low fat milk to 0.53% fat with a 3.20% protein in order to achieve an 12.5% fat in dry matter in the final cheese product. 31,000 lbs. of the standardized milk is pasteurized at 165° F. for 16 seconds and then cooled to 91° F.

### Preparation of Low Fat Swiss Curd

At the beginning of vat fill, as 31,000 lbs. low fat milk is pumped into a Damrow Double O vat, 960 lbs. of the cultured adjunct medium is added. Acid-producing bacteria (1000 g Chr. Hansen HCH12 and 250 ml Chr. Hansen PS-1, obtained from Chr. Hansen Labs, Milwaukee Wis.), are added as a frozen concentrate directly to the vat, 40 minutes prior to set. FD&C yellow color, 40 g, is also added at this time. The combined ingredients are stirred and allowed to ripen at 91° F. for about 40 minutes from the time the acid-producing cultures are added.

After ripening, 2400 ml of cloned microbial rennet (Chymax obtained from Chr. Hansen Labs, Milwaukee Wis.) diluted with 10 times its volume of water, is poured into the ripened milk mixture. The mixture is stirred until the rennet is evenly distributed throughout the milk mixture and then allowed to set without stirring for about 30 minutes.

Once the mix becomes a firm, set coagulum, it is cut mechanically in the vat in the sequence of 2 minutes slow, 2 minutes medium, and 5 minutes fast. The result is a fine cut coagulum that will produce approximately 3/16 inch size curd upon pressing. The curd and whey mixture is slowly stirred in reverse, for 12 minutes, to help firm up the curd prior to the pre-draw and to assure no clumping of the curd.

Approximately one-third of the whey is removed by stopping agitation and drawing off the whey in two stages. The curd and whey are then stirred at fast speed for 3 minutes to ensure uniform curd size prior to cooking.

The cooking of the curd is accomplished by adding hot water, slowly, so that the curd reaches a temperature in the range of from about 90° F. to about 96° F. The temperature and rate of addition of the water is adjusted so that the temperature rise in the vat is consistent over a 30 minute period. The amount of water added is approximately one-third of the amount of whey remaining after the pre-draw.

The cooked curd and diluted whey mixture is slowly stirred until a pH of about 6.45 is reached. The mixture is then stirred at high speed to uniformly disperse the curd. Next, the curd and diluted whey mixture is pumped to a universal drain table and the curd kept under the diluted whey. After filling, the curd is pressed under the diluted whey, prior to removal of the remaining diluted whey. The curd is pressed overnight under approximately 80 psi pressure. After the overnight press, the pH of the curd is between 5.10 and 5.20.

The pressed curd mass is then cut into 10 to 15 lb. blocks, brined for 3 to 8 hours, and then packaged. The packaged cheese product is transferred to a cooler and pre-cooled at 33° F. for 7-14 days prior to curing. The packaged cheese product is then moved to a tempering room and cured at a temperature in the range of 70 to 73° F., for about 10 days, until the proper eye development is reached. At this point, the cured product is transferred back to the cooler for its final aging. Typical Swiss flavor develops in about 45-60 days.

### EXAMPLE 3

A low fat lacey Swiss cheese product is prepared by the following method.

### Preparation of Adjunct Cultured Mixture

An adjunct culture mix is prepared as described in Example 1 above.

### Preparation of Low Fat Milk

Whole milk is separated to standardize the low fat milk to 0.60% fat with a 3.20% protein in order to achieve an 12.5% fat in dry matter in the final cheese product. 31,000 lbs. of the standardized milk is pasteurized at 165° F. for 16 seconds and then cooled to 91° F.

### Preparation of Low Fat Swiss Curd

At the beginning of vat fill, as 31,000 lbs. low fat milk is pumped into a Damrow Double O vat, 960 lbs. of the cultured adjunct medium is added. Acid-producing bacteria (1000 g Chr. Hansen HCH12 and 250 ml Chr. Hansen PS-1, obtained from Chr. Hansen Labs, Milwaukee Wis.), are added as a frozen concentrate directly to the vat, 40 minutes prior to set. At the same time, 40 g FD&C yellow color is added to the milk. The combined ingredients are stirred and allowed to ripen at 90° F. for about 30 minutes from the time the acid-producing cultures are added.

After ripening, 2400 ml of cloned microbial rennet (2×Chymax obtained from Chr. Hansen Labs, Milwaukee Wis.) diluted with 10 times its volume of water, is poured into the ripened milk mixture. The mixture is stirred until the rennet is evenly distributed throughout the milk mixture and then allowed to set without stirring for about 30 minutes.

Once the mix becomes a firm, set coagulum, it is cut mechanically in the vat in the sequence of 2 minutes slow, 2 minutes medium, and 5 minutes fast. The result is a fine cut coagulum that will produce approximately 3/16 inch size curd upon pressing. The curd and whey mixture is slowly stirred in reverse, for 12 minutes, to help firm up the curd prior to the pre-draw and to assure no clumping of the curd.

Approximately one-third of the whey is removed by stopping agitation and drawing off the whey in two stages. The curd and whey are then stirred at fast speed for 3 minutes to ensure uniform curd size prior to cooking.

The cooking of the curd is accomplished by adding hot water, slowly, so that the curd reaches a temperature in the range of from about 90° F. to about 96° F. The temperature and rate of addition of the water is adjusted so that the temperature rise in the vat is consistent over a 30 minute period. The amount of water added is approximately one-third of the amount of whey remaining after the pre-draw.

The cooked curd and diluted whey mixture is slowly stirred until a pH of about 6.45 is reached. The mixture is then stirred at high speed to uniformly disperse the curd. Next, the curd and diluted whey mixture is pumped to a universal drain table and the diluted whey allowed to drain free from the curd. After filling, the curd is pressed for four hours under approximately 80 psi pressure. After pressing, the pH of the curd is between 5.20 and 5.30.

The pressed curd mass is then cut into the 10-15 lb. blocks and brined for 3 to 8 hours, and then packaged. The packaged cheese product is transferred to a cooler and pre-cooled at 40° F. for 7-10 days prior to curing. The packaged cheese product is then moved to a tempering room and cured at a temperature in the range of 70 to 72° F., for about 10 to 14 days, until uniform lace development is obtained. At this point, the cured product is transferred back to the cooler for its final aging. Typical Swiss flavor develops in about 45-60 days.

We claim:

1. A method for preparing an adjunct cultured mixture for use in the preparation of a no fat or a low fat cheese product comprising:
combining from about 1 to about 5 wt. % nonfat dry milk, from about 0.05 to about 1.0 wt. % of at least one food grade, polyanionic gum stabilizer, and from about 90 to about 97 wt. % liquid portion, to form an adjunct culture medium,
inoculating the adjunct culture medium with a flavor-producing bacteria that does not significantly contribute to the overall production of acid; and
incubating the thus formed mixture under conditions sufficient to form a cultured mixture.

2. The method in accordance with claim 1 wherein the liquid portion is water, whey, milk, reconstituted whey or milk or mixtures thereof.

3. The method in accordance with claim 2 wherein the liquid portion is water.

4. The method in accordance with claim 2 wherein the nonfat dry milk is present in an amount from about 1 to about 3 wt. %.

5. The method in accordance with claim 2 wherein the polyanionic gum stabilizer is selected from agar, xanthan, alginate, guar, locust bean, carrageenan, cellulose gels, and mixtures thereof.

6. The method in accordance with claim 5 wherein the amount of polyanionic gum stabilizer is from about 0.1 to about 0.5 wt. %.

7. The method in accordance with claim 5 wherein the flavor-producing bacteria is S. citrovorous, S. diacetylactis, S. cremoris, S. lactis, S. thermophilus, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, propionibacterium species or mixtures thereof.

8. The method in accordance with claim 7 wherein the amount of liquid portion is from about 91 to about 93 wt. %.

9. The method in accordance with claim 7 further comprising including from about 0.5 to about 6 wt. % of a non-ionic thickener with the combination forming the adjunct culture medium.

10. The method in accordance with claim 7 wherein the amount of non-ionic thickener is from about 2 to about 5 wt. %.

11. The method in accordance with claim 10 wherein the non-ionic thickener is a food starch.

12. A method for preparing an adjunct cultured mixture for use in the preparation of a no fat or a low fat cheese product comprising:
combining from about from about 1 to about 3 wt. % nonfat dry milk, from about from about 0.1 to about 0.5 wt. % of at least one food grade, polyanionic gum stabilizer selected from agar, xanthan, alginate, guar, locust bean, carrageenan, cellulose gels, and mixtures thereof, from about 2 to about 5 wt. % of a non-ionic food starch, and from about 91 to about 93 wt. %, water, whey, milk, reconstituted whey or milk or mixtures thereof, to form an adjunct culture medium;
inoculating the adjunct culture medium with a flavor-producing bacteria selected from S. citrovorous, S. diacetylactis, S. cremoris, S. lactis, S. thermophilus, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, propionibacterium species; and
incubating the thus formed mixture under conditions sufficient to form a cultured mixture.

13. A method for preparing a no fat or low-fat cheese product comprising:
combining from about 1 to about 5 wt. % nonfat dry milk, from about from about 0.05 to about 1.0 wt. % of at least one food grade, polyanionic gum stabilizer, and from about 90 to about 97 wt. % of a liquid portion selected from water, whey, milk, reconstituted whey or milk or mixtures thereof, to form an adjunct culture medium;
pasteurizing the adjunct culture medium;
cooling the pasteurized culture medium to a temperature suitable for the growth of flavor-producing bacteria;
inoculating the adjunct culture medium with a flavor-producing bacteria that does not significantly contribute to the overall production of acid to form a mixture;
incubating the mixture to form a cultured mixture;
forming cultured milk by mixing from about 1 to about 10 wt. % of the cultured mixture, with skim milk or low-fat milk and an acid-producing bacteria;
ripening the cultured milk;
adding sufficient clotting enzyme to the ripened milk to form a coagulum;
cutting the coagulum to form a curd in whey mixture;
cooking the curd while in whey;
draining the whey from the curd; and
further processing the curd to produce a no fat or low-fat cheese.

14. The method in accordance with claim 13 wherein the amount of nonfat dry milk is from about 1 to about 3 wt. %.

15. The method in accordance with claim 13 wherein the polyanionic gum stabilizer is selected from agar, xanthan, alginate, guar, locust bean, carrageenan, cellulose gels, and mixtures thereof.

16. The method in accordance with claim 15 wherein the amount of polyanionic gum stabilizer is from about 0.1 to about 0.5 wt. %.

17. The method in accordance with claim 15 wherein the flavor-producing bacteria is selected from S. citrovorous, S. diacetylactis, S. cremoris, S. lactis, S. thermophilus, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, propionibacterium species and mixtures thereof.

18. The method in accordance with claim 17 wherein the amount of liquid portion is from about 91 to about 93 wt. %.

19. The method in accordance with claim 18 wherein the liquid portion is water.

20. The method in accordance with claim 17 further comprising including from about 0.5 to about 6 wt. % of a non-ionic thickener with the combination forming the adjunct culture medium.

21. The method in accordance with claim 17 wherein the amount of non-ionic thickener is from about 2 to about 5 wt. %.

22. The method in accordance with claim 21 wherein the non-ionic thickener is a food starch.

23. The method in accordance with claim 17 wherein the acid-producing bacteria is selected from S. cremoris, S. lactis, S. thermophilus., S. durans, S. faecalis, L. bulgaricus, L. helveticus, and L. lactis.

24. A method for preparing a no fat or low-fat cheese product comprising:
combining from about 1 to about 3 wt. % nonfat dry milk, from about 0.1 to about 0.5 wt. % of at least one food grade, polyanionic gum stabilizer selected from agar, xanthan, alginate, guar, carrageenan, cellulose gels, and mixtures thereof, from about 2 to about 5 wt. % of a non-ionic food starch, and from about 91 to about 93 wt. % water, whey, milk, reconstituted whey or milk or mixtures thereof, to form an adjunct culture medium;
pasteurizing the adjunct culture medium;
cooling the pasteurized culture medium to a temperature suitable for the growth of flavor-producing bacteria;
inoculating the adjunct culture medium with a flavor-producing bacteria selected from S. citrovorous, S. diacetylactis, S. cremoris, S. lactis, S. thermophilus, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, propionibacterium species and mixtures thereof to form a mixture;
incubating the mixture to form a cultured mixture;
forming cultured milk by mixing from about 1 to about 10 wt. % of the cultured mixture, with skim milk or low-fat milk and an acid-producing bacteria selected from S. cremoris, S. lactis, S. thermophilus., S. durans, S. faecalis, L. bulgaricus, L. helveticus, and L. lactis;
is ripening the cultured milk;
adding sufficient clotting enzyme to the ripened milk to form a coagulum;
cutting the coagulum to form a curd in whey mixture;
cooking the curd while in whey;
draining the whey from the curd and further processing the curd to produce a no fat or low-fat cheese.

25. A method for preparing a no fat or low-fat cheese product comprising:
mixing skim milk or low-fat milk with a sufficient amount of an acid-producing bacteria under conditions to form cultured milk;
ripening the cultured milk;
adding sufficient clotting enzyme to the ripened milk to form a coagulum;
cutting the coagulum to form a curd in whey mixture;
removing from about 10 wt. % to about 50 wt. % of the whey from the mixture;
adding hot water to dilute the whey and extract lactose and whey solids from the curd;
cooking the curd while in diluted whey;
draining the diluted whey from the curd; and
further processing the curd to produce a no fat or low-fat cheese.

26. The method in accordance with claim 25 wherein the hot water has a temperature of from about 110° to about 150° F.

27. The method in accordance with claim 25 wherein the hot water cooks the curd.

28. The method in accordance with claim 27 wherein the hot water is added over a period of from about 20 to about 40 minutes to bring the temperature of the curd to from about 90° to about 120° F.

29. A method for preparing a no fat or low-fat cheese product comprising:
combining from about 1 to about 5 wt. % nonfat dry milk, from about from about 0.05 to about 1.0 wt. % of at least one food grade, polyanionic gum stabilizer, and from about 90 to about 97 wt. % liquid portion, to form an adjunct culture medium;
pasteurizing the adjunct culture medium;
cooling the pasteurized culture medium to a temperature suitable for the growth of flavor-producing bacteria;
inoculating the adjunct culture medium with a flavor-producing bacteria that does not significantly contribute to the overall production of acid to form a mixture;
incubating the mixture to form a cultured mixture;
forming cultured milk by mixing from about 1 to about 10 wt. % of the cultured mixture, with skim milk or low-fat milk and an acid-producing bacteria;
ripening the cultured milk;
adding sufficient clotting enzyme to the ripened milk to form a coagulum;
cutting the coagulum to form a curd in whey mixture;
removing from about 10 wt. % to about 50 wt. % of the whey from the mixture;
adding hot water to dilute the whey and extract lactose and whey solids from the curd;
cooking the curd while in diluted whey;
draining the diluted whey; and
further processing the curd to produce a no fat or low-fat cheese product.

30. The method in accordance with claim 29 wherein the liquid portion is water, whey, milk, reconstituted whey or milk or mixtures thereof.

31. The method in accordance with claim 30 wherein the liquid portion is water.

32. The method in accordance with claim 29 wherein the hot water has a temperature of from about 110° to about 150° F.

33. The method in accordance with claim 32 wherein the hot water cooks the curd.

34. The method in accordance with claim 33 wherein the hot water is added over a period of from about 20 to about 40 minutes to bring the temperature of the curd to from about 90° to about 120° F.

35. A method for preparing a no fat or low-fat cheese product comprising:
combining from about 1 to about 3 wt. % nonfat dry milk, from about 0.1 to about 0.5 wt. % of at least one food grade, polyanionic gum stabilizer selected from agar, xanthan, alginate, guar, carrageenan, cellulose gels, and mixtures thereof, from about 2 to about 5 wt. % of a non-ionic food starch, and from about 91 to about 93 wt. % water, whey, milk, reconstituted whey or milk or mixtures thereof, to form an adjunct culture medium;
pasteurizing the adjunct culture medium;
cooling the pasteurized culture medium to a temperature suitable for the growth of flavor-producing bacteria;
inoculating the adjunct culture medium with a flavor-producing bacteria selected from S. citrovorous, S. diacetylactis, S. cremoris, S. lactis, S. thermophilus, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, propionibacterium species and mixtures thereof to form a mixture;
incubating the mixture to form a cultured mixture;
forming cultured milk by mixing from about 1 to about 10 wt. % of the cultured mixture, with skim milk or low-fat milk and an acid-producing bacteria selected from S. cremoris, S. lactis, S. thermophilus., S. durans, S. faecalis, L bulgaricus, L. helveticus, and L. lactis;
ripening the cultured milk;
adding sufficient clotting enzyme to the ripened milk to form a coagulum;
cutting the coagulum to form a curd in whey mixture;
removing from about 10 wt. % to about 50 wt. % of the whey from the mixture;
adding water having a temperature of from about 110° to about 150° F. over a period of from about 20 to about 40 minutes to dilute the whey, extract lactose and whey solids from the curd, and to bring the temperature of the curd to from about 90° to about 120° F., thereby cooking the curd;
draining the diluted whey from the curd; and
further processing the curd to produce a no fat cheese product.

36. A method for preparing a no fat or low-fat cheese product comprising:
mixing skim milk or low-fat milk and a sufficient amount of an acid-producing bacteria under conditions to form a cultured milk;
ripening the cultured milk;
adding sufficient clotting enzyme to the ripened milk to form a coagulum;
cutting the coagulum to form a curd in whey mixture;
cooking the curd while in whey;
draining whey from the curd;
salting the curd with a mixture of salt and an emulsifying salt; and
further processing the curd to produce a no fat or low fat cheese product.

37. The method in accordance with claim 36 wherein the amount of emulsifying salt is from about 0.1 to about 1.0 wt. %, based on the weight of the drained curd.

38. The method in accordance with claim 37 wherein the emulsifying salt is sodium citrate, potassium citrate, sodium phosphate, potassium phosphate, or combinations thereof.

39. A method for preparing a no fat or low-fat cheese product comprising:
combining from about 1 to about 5 wt. % nonfat dry milk, from about from about 0.05 to about 1.0 wt. % of at least one food grade, polyanionic gum stabilizer, and from about 90 to about 97 wt. % water, whey, milk, reconstituted whey or milk or mixtures thereof, to form an adjunct culture medium;
pasteurizing the adjunct culture medium;
cooling the pasteurized culture medium to a temperature suitable for the growth of flavor-producing bacteria;
inoculating the adjunct culture medium with a flavor-producing bacteria that does not significantly contribute to the overall production of acid to form a mixture;
incubating the mixture to form a cultured mixture;
forming cultured milk by mixing from about 1 to about 10 wt. % of the cultured mixture, with skim milk or low-fat milk and an acid-producing bacteria;
ripening the cultured milk;
adding sufficient clotting enzyme to the ripened milk to form a coagulum;
cutting the coagulum to form a curd in whey mixture;
cooking the curd while in whey;
draining the whey from the curd;
salting the drained curd with a mixture of salt and an emulsifying salt; and
further processing the curd to produce a no fat or low fat cheese product.

40. The method in accordance with claim 39 wherein the amount of emulsifying salt is from about 0.1 to about 1.0 wt. %, based on the weight of the drained curd.

41. The method in accordance with claim 40 wherein the emulsifying salt is sodium citrate, potassium citrate, sodium phosphate, potassium phosphate, or combinations thereof.

42. A method for preparing a no fat or low-fat cheese product comprising:
mixing skim milk or low-fat milk with a sufficient amount of an acid-producing bacteria under conditions to form a cultured milk;
ripening the cultured milk;
adding sufficient clotting enzyme to the ripened milk to form a coagulum;
cutting the coagulum to form a curd in whey mixture;
removing from about 10% to about 50% of the whey from the mixture;
adding hot water to dilute the whey and extract lactose and whey solids from the curd;
cooking the curd while in the diluted whey;
draining the diluted whey from the curd;
salting the drained curd with a mixture of salt and an emulsifying salt; and
further processing the curd to produce a no fat or low fat cheese product.

43. The method in accordance with claim 42 wherein the amount of emulsifying salt is from about 0.1 to about 1.0 wt. %, based on the weight of the drained curd.

44. The method in accordance with claim 43 wherein the emulsifying salt is sodium citrate, potassium citrate, sodium phosphate, potassium phosphate, or combinations thereof.

45. A method for preparing a no fat or low-fat cheese product comprising:
combining from about 1 to about 3 wt. % nonfat dry milk, from about 0.1 to about 0.5 wt. % of at least one food grade, polyanionic gum stabilizer selected from agar, xanthan, alginate, guar, locust bean, carrageenan, cellulose gels, and mixtures thereof, from about 2 to about 5 wt. % of a non-ionic food starch, and from about 91 to about 93 wt. % water, whey, milk, reconstituted whey or milk or mixtures thereof, to form an adjunct culture medium;
pasteurizing the adjunct culture medium;
cooling the pasteurized culture medium to a temperature suitable for the growth of flavor-producing bacteria;
inoculating the adjunct culture medium with a flavor-producing bacteria selected from S. citrovorous, S. diacetylactis, S. cremoris, S. lactis, S. thermophilus, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, propionibacterium species and mixtures thereof to form a mixture;
incubating the mixture to form a cultured mixture;
forming cultured milk by mixing from about 1 to about 10 wt. % of the cultured mixture, with skim milk or low-fat milk and an acid-producing bacteria selected from S. cremoris, S. lactis, S. thermophilus., S. durans, S. faecalis, L. bulgaricus, L. helveticus, and L. lactis;
ripening the cultured milk;
adding sufficient clotting enzyme to the ripened milk to form a coagulum;
cutting the coagulum to form a curd in whey mixture;
removing from about 10% to about 50% of the whey from the mixture;
adding hot water having a temperature of from about 110° to about 150° F. over a period of from about 20 to about 40 minutes to dilute the whey, extract lactose and whey solids from the curd, and to bring the temperature of the curd to from about 90° to about 120° F., thereby cooking the curd;
draining the diluted whey from the curd;
salting the drained curd with a mixture of salt and from about 0.1 to about 1.0 wt. % of an emulsifying salt selected from sodium citrate, potassium citrate, sodium phosphate, potassium phosphate, or combinations thereof; and
further processing the curd to produce a no fat or low fat cheese product.

46. An adjunct cultured mixture for use in the preparation of a no fat or a low fat cheese product comprising:
an adjunct culture medium including about 1 to about 5 wt. % nonfat dry milk, from about from about 0.05 to about 1.0 wt. % of at least one food grade, polyanionic gum stabilizer, and from about 90 to about 97 wt. % of a liquid portion selected from water, whey, milk, reconstituted whey or milk or mixtures thereof, to form inoculated with a flavor-producing bacteria that does not significantly contribute to the overall production of acid to form the cultured mixture.

47. The adjunct cultured mixture in accordance with claim 46 wherein the liquid portion is water.

48. The adjunct cultured mixture in accordance with claim 46 wherein the amount of nonfat dry milk is from about 1 to about 3 wt. %.

49. The adjunct cultured mixture in accordance with claim 46 wherein the polyanionic gum stabilizer is selected from agar, xanthan, alginate, guar, locust bean, carrageenan, cellulose gels, and mixtures thereof.

50. The adjunct cultured mixture in accordance with claim 49 wherein the amount of polyanionic gum stabilizer is from about 0.1 to about 0.5 wt. %.

51. The adjunct cultured mixture in accordance with claim 49 wherein the flavor-producing bacteria is selected from S. citrovorous, S. diacetylactis, S. cremoris, S. lactis, S. thermophilus, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, propionibacterium species and mixtures thereof.

52. The adjunct cultured mixture in accordance with claim 51 wherein the amount of the liquid portion is from about 91 to about 93 wt. %.

53. The adjunct cultured mixture in accordance with claim 50 further comprising from about 0.5 to about 6 wt. % of a non-ionic thickener.

54. The adjunct cultured mixture in accordance with claim 51 wherein the amount of non-ionic thickener is from about 2 to about 5 wt. %.

55. The method in accordance with claim 54 wherein the non-ionic thickener is a food starch.

56. An adjunct cultured mixture for use in the preparation of a no fat or a low fat cheese product comprising:
an adjunct culture medium including from about from about 1 to about 3 wt. % nonfat dry milk, from about from about 0.1 to about 0.5 wt. % of at least one food grade, polyanionic gum stabilizer selected from agar, xanthan, alginate, guar, locust bean, carrageenan, cellulose gels, and mixtures thereof, from about 2 to about 5 wt. % of a non-ionic food starch and from about 91 to about 93 wt. % water, whey, milk, reconstituted whey or milk or mixtures thereof, inoculated with a flavor-producing bacteria selected from S. citrovorous, S. diacetylactis, S. cremoris, S. lactis, S. thermophilus, L. acidophilus, L. bulgaricus, L. brevis, L. casei, L. paracasei, L. delbruekii, L. fermenti, L. helveticus, L. lactis, L. plantarurn, L. pseudoplantarum, leuconostoc citrovorum, leuconostoc mesenteroides, Bacteriumlinesn, Micrococcus caseolyticus, Pediococcus cerevisiae, Pseudomonas fraga, Brevibacteriun, propionibacterium species and mixtures thereof to form the cultured mixture.
